(19) United States
(12) Patent Application Publication
(10) Pub. No.: US 2020/0193372 A1
(43) Pub. Date: Jun. 18, 2020

(54) INFORMATION PROCESSING METHOD AND APPARATUS

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventors: Yanchao Miao, Beijing (CN); Yingying Qi, Beijing (CN)

(21) Appl. No.: 16/636,074

(22) PCT Filed: Apr. 11, 2018
(86) PCT No.: PCT/CN2018/082688

§ 371 Date: Feb. 3, 2020

(30) Foreign Application Priority Data
Sep. 8, 2017 (CN) 201710805880.3

(51) Int. Cl. G06Q 10/08; G06F 16/28

(52) U.S. Cl. CPC G06Q 10/0835; G06F 16/285; G06Q 10/0838

(57) ABSTRACT

Disclosed are an information processing method and apparatus. The method includes: acquiring a to-be-delivered order set, a to-be-delivered order comprising a delivery address; mapping, for each to-be-delivered order in the to-be-delivered order set, a delivery address included in the to-be-delivered order to a coordinate point, and determining a delivery area identifier corresponding to the to-be-delivered order in a preset delivery area identifier set based on the coordinate point obtained by the mapping; dividing to-be-delivered orders corresponding to a given delivery area identifier in the to-be-delivered order set into a given to-be-delivered order group; and setting a group identifier for each divided to-be-delivered order group, and generating a corresponding relationship between the group identifier and a delivery area identifier corresponding to the to-be-delivered order group.

### CROSS-REFERENCE TO RELATED APPLICATIONS

The present patent application claims priority to Chinese Patent Application No. 201710805880.3, filed on Sep. 8, 2017 by the applicants BEIJING JINGDONG SHANGKE INFORMATION TECHNOLOGY CO., LTD., and BEIJING JINGDONG CENTURY TRADING CO., LTD., and entitled “INFORMATION PROCESSING METHOD AND APPARATUS,” the entire contents of which are herein incorporated by reference.

### TECHNICAL FIELD

The present disclosure relates to the field of computer technology, specifically to the field of Internet technology, and more specifically to a method and apparatus for processing information.

### BACKGROUND

At present, before delivering goods to customers, a deliveryman usually needs to scan all orders or parcels at a delivery station once to complete delivery. When there is a large number of orders, it will take a long time for the deliveryman to scan each order, thereby affecting the delivery efficiency of the deliveryman.

Therefore, how to generate information for delivery taking process of the deliveryman by effectively using the to-be-delivered order set, to shorten the delivery time of the deliveryman, is a problem worthy to be studied.

### SUMMARY

Embodiments of the present disclosure are directed to provide an improved method and apparatus for processing information so as to solve a part of the technical problems mentioned in the background portion.

In a first aspect, an embodiment of the present disclosure provides a method for processing information, including: acquiring a to-be-delivered order set, a to-be-delivered order including a delivery address; mapping, for each to-be-delivered order in the to-be-delivered order set, a delivery address included in the to-be-delivered order to a coordinate point, and determining a delivery area identifier corresponding to the to-be-delivered order in a preset delivery area identifier set based on the coordinate point obtained by the mapping; dividing to-be-delivered orders corresponding to a given delivery area identifier in the to-be-delivered order set into a given to-be-delivered order group; and setting a group identifier for each divided to-be-delivered order group, and generating a corresponding relationship between the group identifier and a delivery area identifier corresponding to the to-be-delivered order group.

In some embodiments, each delivery area identifier in the delivery area identifier set has a corresponding coordinate point sequence, each coordinate point in the coordinate point sequence is a point on a boundary of a delivery area indicated by the delivery area identifier, the delivery area identifier further has a corresponding geometrical pattern, and the geometrical pattern is an enclosed pattern formed by connecting adjacent coordinate points in the coordinate point sequence.

In some embodiments, the determining a delivery area identifier corresponding to the to-be-delivered order in a preset delivery area identifier set based on the coordinate point obtained by the mapping includes: drawing a half line along a horizontal direction on a two-dimensional plane with the coordinate point obtained by the mapping as a starting point, determining, for each delivery area identifier in the delivery area identifier set, a total number of intersections of sides of the geometrical pattern corresponding to the delivery area identifier and the half line, and using, in response to the total number being an odd number, the delivery area identifier as the delivery area identifier corresponding to the to-be-delivered order.

In some embodiments, the delivery area identifier set has a corresponding data structure, the data structure includes leaf nodes and non-leaf nodes, where a leaf node is a node comprising no subnode, and each of the non-leaf nodes includes at least two subnodes; each leaf node and each non-leaf node included in the data structure correspond to different rectangular frames respectively, and store position information of corresponding rectangular frames; a rectangular frame corresponding to each leaf node is a minimal bounding rectangle of the geometrical pattern corresponding to the delivery area identifier in the delivery area identifier set; and for the each non-leaf node of the non-leaf nodes, a rectangular frame corresponding to each subnode included in the non-leaf node is contained within a rectangular frame corresponding to the non-leaf node.

In some embodiments, the determining a delivery area identifier corresponding to the to-be-delivered order in a preset delivery area identifier set based on the coordinate point obtained by the mapping further includes: determining a target leaf node in the data structure based on the coordinate point obtained by the mapping and the position information of the rectangular frames respectively corresponding to the non-leaf node and the leaf node included in the data structure, where a rectangular frame corresponding to the target leaf node is a rectangular frame of the coordinate point obtained by the mapping; and drawing a half line along a horizontal direction on a two-dimensional plane with the coordinate point obtained by the mapping as a starting point, determining a total number of intersections of the drawn half line and sides of a geometrical pattern within the rectangular frame corresponding to the target leaf node, and using, in response to the determined total number being an odd number, a delivery area identifier corresponding to the geometrical pattern within the rectangular frame corresponding to the target leaf node as the delivery area identifier corresponding to the to-be-delivered order.

In some embodiments, to-be-delivered orders in the to-be-delivered order set are derived from an order set, each order in the order set includes identifier information, and the to-be-delivered order set is generated by: determining, for the each order in the order set, whether a preset identifier in a preset identifier set exists in the identifier information included in the order, and classifying, in response to no preset identifier in the preset identifier set exists in the identifier information included in the order, the order into the to-be-delivered order set.

In some embodiments, each delivery area identifier in the delivery area identifier set has a corresponding delivery mode identifier, the delivery mode identifier being a delivery mode identifier for indicating self-delivery or a delivery mode identifier for indicating delivery by third party logistics, and the delivery mode identifier for indicating self-delivery and the delivery mode identifier for indicating delivery by the third party logistics correspond to different group identifier generating approaches respectively.

In some embodiments, the setting a group identifier for each divided to-be-delivered order group includes: generating, for the each divided to-be-delivered order group, a group identifier based on a group identifier generating approach corresponding to a delivery mode identifier associated with the divided to-be-delivered order group, and setting the generated group identifier as the group identifier of the to-be-delivered order group.

In some embodiments, the each to-be-delivered order in the to-be-delivered order set further includes an order identifier; and the method further includes: generating, for the each divided to-be-delivered order group, a corresponding relationship between the group identifier of the to-be-delivered order group and an order identifier of a to-be-delivered order included in the to-be-delivered order group.

In some embodiments, the method further includes:

determining, in response to receiving prompt information comprising an order identifier of an abnormal order, a target to-be-delivered order group of the abnormal order from the divided to-be-delivered order groups, removing the abnormal order from the target to-be-delivered order group, and withdrawing a corresponding relationship between the order identifier of the abnormal order and a group identifier of the target to-be-delivered order group, where the abnormal order is an undeliverable order in a divided to-be-delivered order group.

In some embodiments, each delivery area identifier in the delivery area identifier set has a corresponding deliveryman identifier; and the method further includes: sending, for each delivery area identifier in the delivery area identifier set, a group identifier corresponding to the delivery area identifier to a terminal device of a deliveryman indicated by the deliveryman identifier corresponding to the delivery area identifier.

In some embodiments, the method further includes: determining, in response to receiving delivery information comprising the deliveryman identifier and the group identifier, whether the deliveryman identifier and the group identifier included in the delivery information have an association relationship, and returning to, in response to the deliveryman identifier and the group identifier included in the delivery information having the association relationship, a to-be-delivered order group indicated by the group identifier included in the delivery information.

In a second aspect, an embodiment of the present disclosure provides an apparatus for processing information, including: an acquiring unit configured to acquire a to-be-delivered order set, each to-be-delivered order in the to-be-delivered order set including a delivery address; a determining unit configured to map, for each to-be-delivered order in the to-be-delivered order set, the delivery address included in the to-be-delivered order to a coordinate point, and determine a delivery area identifier corresponding to the to-be-delivered order in a preset delivery area identifier set based on the coordinate point obtained by the mapping; a dividing unit configured to divide to-be-delivered orders corresponding to a given delivery area identifier in the to-be-delivered order set into a given to-be-delivered order group; and a generating unit configured to set a group identifier for each divided to-be-delivered order group, and generate a corresponding relationship between the group identifier and a delivery area identifier corresponding to the to-be-delivered order group.

In some embodiments, each delivery area identifier in the delivery area identifier set has a corresponding coordinate point sequence, each coordinate point in the coordinate point sequence is a point on a boundary of a delivery area indicated by the delivery area identifier, the delivery area identifier further has a corresponding geometrical pattern, and the geometrical pattern is an enclosed pattern formed by connecting adjacent coordinate points in the coordinate point sequence.

In some embodiments, the determining unit includes: a first determining subunit configured to draw a half line along a horizontal direction on a two-dimensional plane with the coordinate point obtained by the mapping as a starting point, determine, for each delivery area identifier in the delivery area identifier set, a total number of intersections of sides of the geometrical pattern corresponding to the delivery area identifier and the half line, and use, in response to the total number being an odd number, the delivery area identifier as the delivery area identifier corresponding to the to-be-delivered order.

In some embodiments, the delivery area identifier set has a corresponding data structure, the data structure includes leaf nodes and non-leaf nodes, where a leaf node is a node including no subnode, and each of the non-leaf nodes includes at least two subnodes; each leaf node and each non-leaf node included in the data structure corresponds to different rectangular frames respectively, and stores position information of corresponding rectangular frames; a rectangular frame corresponding to each leaf node is a minimal bounding rectangle of the geometrical pattern corresponding to the delivery area identifier in the delivery area identifier set; and for each non-leaf node of the non-leaf nodes, a rectangular frame corresponding to each subnode included in the non-leaf node is contained within a rectangular frame corresponding to the non-leaf node.

In some embodiments, the determining unit further includes: a second determining subunit configured to determine a target leaf node in the data structure based on the coordinate point obtained by the mapping and the position information of the rectangular frames respectively corresponding to the non-leaf nodes and the leaf nodes included in the data structure, where a rectangular frame corresponding to the target leaf node is a rectangular frame of the coordinate point obtained by the mapping; and a third determining subunit configured to draw a half line along a horizontal direction on a two-dimensional plane with the coordinate point obtained by the mapping as a starting point, determine a total number of intersections of the drawn half line and sides of a geometrical pattern within the rectangular frame corresponding to the target leaf node, and use, in response to the determined total number being an odd number, a delivery area identifier corresponding to the geometrical pattern within the rectangular frame corresponding to the target leaf node as the delivery area identifier corresponding to the to-be-delivered order.

In some embodiments, the to-be-delivered orders in the to-be-delivered order set are derived from an order set, each order in the order set includes identifier information, and the to-be-delivered order set is generated by: determining, for each order in the order set, whether a preset identifier in a preset identifier set exists in the identifier information included in the order, and classifying, in response to no preset identifier in the preset identifier set exists in the identifier information included in the order, the order into the to-be-delivered order set.

In some embodiments, each delivery area identifier in the delivery area identifier set has a corresponding delivery mode identifier, the delivery mode identifier may be a delivery mode identifier for indicating self-delivery or a delivery mode identifier for indicating delivery by third party logistics, and the delivery mode identifier for indicating self-delivery and the delivery mode identifier for indicating delivery by the third party logistics correspond to different group identifier generating approaches respectively.

In some embodiments, the generating unit includes: a setting subunit configured to generate, for each divided to-be-delivered order group, a group identifier based on a group identifier generating approach corresponding to a delivery mode identifier associated with the divided to-be-delivered order group, and set the generated group identifier as the group identifier of the divided to-be-delivered order group.

In some embodiments, each to-be-delivered order in the to-be-delivered order set further includes an order identifier; and the apparatus further includes: a first generating unit configured to generate, for each divided to-be-delivered order group, a corresponding relationship between the group identifier of the divided to-be-delivered order group and an order identifier of a to-be-delivered order included in the to-be-delivered order group.

In some embodiments, the apparatus 700 may further include: a removing unit configured to determine, in response to receiving prompt information including an order identifier of an abnormal order, a target to-be-delivered order group of the abnormal order from the divided to-be-delivered order groups, remove the abnormal order from the target to-be-delivered order group, and withdraw a corresponding relationship between the order identifier of the abnormal order and a group identifier of the target to-be-delivered order group, where the abnormal order may be an undeliverable order in a divided to-be-delivered order group.

In some embodiments, each delivery area identifier in the delivery area identifier set has a corresponding deliveryman identifier; and the apparatus further includes: a first sending unit configured to send, for each delivery area identifier in the delivery area identifier set, a group identifier corresponding to the delivery area identifier to a terminal device of a deliveryman indicated by the deliveryman identifier corresponding to the delivery area identifier.

In some embodiments, the apparatus further includes: a second sending unit configured to determine, in response to receiving delivery information including the deliveryman identifier and the group identifier, whether the deliveryman identifier and the group identifier included in the delivery information have an association relationship, and return to, in response to the deliveryman identifier and the group identifier included in the delivery information having the association relationship, a to-be-delivered order group indicated by the group identifier included in the delivery information.

In a third aspect, an embodiment of the present disclosure provides an electronic device, including: one or more processors; and a storage apparatus configured to store one or more programs, where the one or more programs, when executed by the one or more processors, cause the one or more processors to implement the method according to any implementation in the first aspect.

In a fourth aspect, an embodiment of the present disclosure provides a computer readable storage medium, storing a computer program thereon, where the program, when executed by a processor, implements the method according to any implementation in the first aspect.

The method and apparatus for processing information provided by embodiments of the present disclosure acquire a to-be-delivered order set, and map a delivery address included in each to-be-delivered order in the acquired to-be-delivered order set to a coordinate point, to facilitate determining a delivery area identifier corresponding to the to-be-delivered order in a preset delivery area identifier set based on the coordinate point, then divide to-be-delivered orders corresponding to a given delivery area identifier in the to-be-delivered order set into a given to-be-delivered order group, and set a group identifier for each divided to-be-delivered order group, to facilitate generating a corresponding relationship between the group identifier and a delivery area identifier corresponding to the divided to-be-delivered order group, thereby effectively using the determined delivery area identifier corresponding to the to-be-delivered order, and achieving highly targeted information generation.

Further, the corresponding relationship between the generated group identifier and the delivery area identifier is applied to the delivery taking process of the deliveryman, such that the deliveryman can quickly acquire a to-be-delivered order group indicated by the group identifier, and further know about the delivery area of the delivery address of the to-be-delivered order, thereby shortening the delivery time of the deliveryman to improve the delivery efficiency of the deliveryman.

### BRIEF DESCRIPTION OF THE DRAWINGS

After reading detailed description of non-limiting embodiments with reference to the following accompanying drawings, other features, objectives and advantages of the present disclosure will become more apparent.

FIG. 1 is a diagram of an example system architecture in which embodiments of the present disclosure may be implemented;

FIG. 2 is a flowchart of a method for processing information according to an embodiment of the present disclosure;

FIG. 3 is a schematic diagram of a method for determining a delivery area identifier corresponding to a to-be-delivered order according to an embodiment of the present disclosure;

FIG. 4a is a schematic diagram of a data structure according to an embodiment of the present disclosure;

FIG. 4b is a schematic diagram of rectangular frames corresponding to a leaf node and a non-leaf node included in the data structure shown in FIG. 4a respectively;

FIG. 5 is a schematic diagram of an application scenario of the method for processing information according to an embodiment of the present disclosure;

FIG. 6 is a flowchart of the method for processing information according to another embodiment of the present disclosure;

FIG. 7 is a schematic structural diagram of an apparatus for processing information according to an embodiment of the present disclosure; and

FIG. 8 is a schematic structural diagram of a computer system adapted to implement an electronic device of embodiments of the present disclosure.

### DETAILED DESCRIPTION OF EMBODIMENTS

The present disclosure will be further described below in detail in combination with the accompanying drawings and embodiments. It should be understood that the specific embodiments described herein are merely used for explaining the relevant disclosure, rather than limiting the disclosure. In addition, it should be further noted that, for the ease of description, only the parts related to the relevant disclosure are shown in the accompanying drawings.

It should be noted that some embodiments in the present disclosure and some features in the disclosure may be combined with each other on a non-conflict basis. The present disclosure will be described below in detail with reference to the accompanying drawings and in combination with the embodiments.

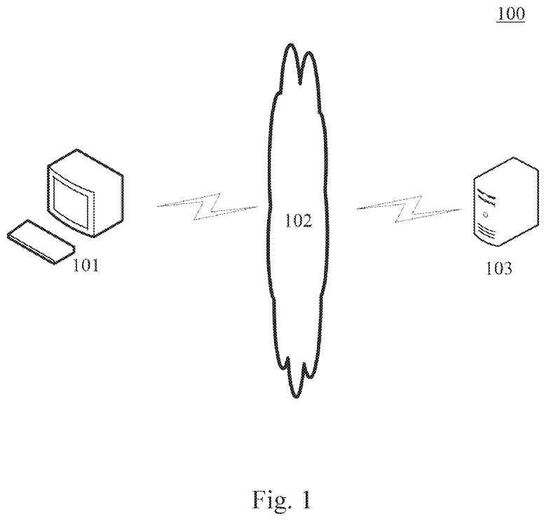

FIG. 1 shows an example system architecture 100 in which a method for processing information or an apparatus for processing information of embodiments of the present disclosure may be implemented.

As shown in FIG. 1, the system architecture 100 may include an information processing terminal 101, a network 102, and a server 103. The network 102 serves as a medium providing a communication link between the information processing terminal 101 and the server 103. The network 102 may include various types of connections, such as wired or wireless communication links, or optical cables.

A user may interact with the server 103 using the information processing terminal 101 via the network 102, for example, to receive or send a message. The information processing terminal 101 may be provided with various communication client applications, such as a web browser application, and an information processing application. Here, the information processing terminal 101, for example, may acquire a to-be-delivered order set from the server 103, and process the to-be-delivered order set.

The information processing terminal 101 may be various electronic devices, including but not limited to a smart phone, a tablet computer, a laptop portable computer, a desktop computer, and the like. The information processing terminal 101, for example, may be a terminal device provided within a delivery station.

The server 103 may be a server providing various services, e.g., a server storing the to-be-delivered order set.

It should be noted that the method for processing information provided by some embodiments of the present disclosure is generally executed by the information processing terminal 101. Accordingly, the apparatus for processing information is generally provided in the information processing terminal 101.

It should be understood that the numbers of information processing terminals, networks, and servers in FIG. 1 are merely illustrative. Any number of information processing terminals, networks, and servers may be provided based on actual requirements.

It should be noted that when the to-be-delivered order set is pre-stored in the information processing terminal 101 locally, the system architecture 100 may not include the server 103.

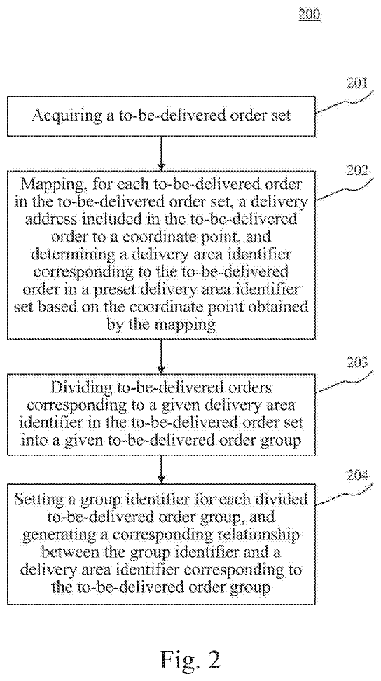

Further referring to FIG. 2, a process 200 of a method for processing information according to an embodiment of the present disclosure is shown. The process 200 of the method for processing information includes the following steps.

Step 201: acquiring a to-be-delivered order set.

In the present embodiment, the to-be-delivered order set may be pre-stored in a server in remote communication connection with an electronic device (e.g., the information processing terminal 101 shown in FIG. 1) on which the method for processing information runs. The electronic device may acquire the to-be-delivered order set from the server through wired connection or wireless connection. Of course, when the to-be-delivered order set is pre-stored in the electronic device locally, the electronic device may alternatively acquire the to-be-delivered order set locally. A to-be-delivered order may include a delivery address.

In some alternative implementations of the present embodiment, the to-be-delivered orders in the to-be-delivered order set may be derived from an order set. Each order in the order set may include identifier information. The to-be-delivered order set may be generated through the following steps: determining, for each order in the order set, whether a preset identifier in a preset identifier set exists in the identifier information included in the order, and classifying, in response to no preset identifier in the preset identifier set exists in the identifier information included in the order, the order into the to-be-delivered order set. It should be noted that the to-be delivered order set may be generated by the electronic device or the server through executing the steps. The present embodiment does not pose any limitation on contents in this aspect.

It should be noted that the order set may be pre-stored in the electronic device locally or in the server. The identifier information included in the order, for example, may include a payment mode identifier, a delivery mode identifier, a luxury order identifier, a high amount order identifier, and the like. The payment mode identifier, for example, may include at least one of the following items: a payment mode identifier for characterizing a payment mode being online payment, a payment mode identifier for characterizing a payment mode being cash on delivery, a payment mode identifier for characterizing a payment mode being cash payment, or the like. The delivery mode identifier, for example, may include at least one of the following items: a delivery mode identifier for characterizing a delivery mode being self-pickup, a delivery mode identifier for characterizing a delivery mode being self-delivery, or a delivery mode identifier for characterizing a delivery mode being delivery by third-party logistics. The luxury order identifier, for example, may include a luxury order identifier for characterizing an order being a luxury order and/or a luxury order identifier for characterizing an order not being a luxury order. The high amount order identifier, for example, may include a high amount order identifier for characterizing an order being a high amount order and/or a high amount order identifier for characterizing an order not being a high amount order.

Here, the preset identifier set, for example, may include at least one of the following items: a delivery mode identifier for characterizing a delivery mode being self-pickup, a luxury order identifier for characterizing an order being a luxury order, or a high amount order identifier for characterizing an order being a high amount order. It should be noted that the preset identifier set may be adjusted based on actual requirements. The present embodiment does not pose any limitation on contents in this aspect.

Step 202: mapping, for each to-be-delivered order in the to-be-delivered order set, a delivery address included in the to-be-delivered order to a coordinate point, and determining a delivery area identifier corresponding to the to-be-delivered order in a preset delivery area identifier set based on the coordinate point obtained by the mapping.

In the present embodiment, after the electronic device acquires the to-be-delivered order set, for each to-be-delivered order in the to-be-delivered order set, the electronic device may map the delivery address included in the to-be-delivered order to the coordinate point, and determine the delivery area identifier corresponding to the to-be-delivered order in the preset delivery area identifier set based on the coordinate point obtained by the mapping. The coordinate point obtained by the mapping may be a longitude and latitude coordinate point.

It should be noted that the electronic device may map the delivery address included in the to-be-delivered order to the coordinate point by a preset Geographic Information System (GIS). The GIS is sometimes referred to as a “geoscience information system,” and is a specific and very important spatial information system. The GIS is a technology system of collecting, storing, managing, computing, analyzing, displaying, and describing relevant geographical distribution data in a space of the whole or a part of the epigeosphere (including the atmosphere) under the support of computer hardware and software systems.

In addition, the electronic device may locally store an information list for recording a corresponding relationship between a coordinate point and a delivery area identifier. Each piece of information in the information list may include a coordinate point and a delivery area identifier corresponding to the coordinate point. For any to-be-delivered order, after mapping a delivery address included in the to-be-delivered order to a coordinate point, the electronic device may search the information list for a target coordinate point identical to the coordinate point, and in response to finding out the target coordinate point identical to the coordinate point, the electronic device may use a delivery area identifier corresponding to the target coordinate point as the delivery area identifier corresponding to the to-be-delivered order.

In some alternative implementations of the present embodiment, each delivery area identifier in the delivery area identifier set may have a corresponding coordinate point sequence, each coordinate point in the coordinate point sequence may be a point on a boundary of a delivery area indicated by the delivery area identifier, the delivery area identifier may further have a corresponding geometrical pattern, and the geometrical pattern may be an enclosed pattern formed by connecting adjacent coordinate points in the coordinate point sequence. Here, the coordinate point in the coordinate point sequence may be a longitude and latitude coordinate point.

In some alternative implementations of the present embodiment, for each to-be-delivered order in the to-be-delivered order set, after the electronic device maps the delivery address included in the to-be-delivered order to the coordinate point, the electronic device may determine the delivery area identifier corresponding to the to-be-delivered order by: drawing a half line along a horizontal direction on a two-dimensional plane with the coordinate point obtained by the mapping as a starting point, determining, for each delivery area identifier in the delivery area identifier set, a total number of intersections of sides of the geometrical pattern corresponding to the delivery area identifier and the half line, and using, in response to the total number being an odd number, the delivery area identifier as the delivery area identifier corresponding to the to-be-delivered order.

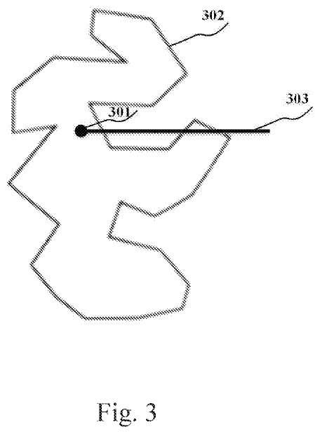

As shown in FIG. 3, FIG. 3 shows a schematic diagram of a method for determining a delivery area identifier corresponding to a to-be-delivered order. FIG. 3 shows a coordinate point 301, an irregular geometrical pattern 302 having a plurality of sides, and a half line 303 with the coordinate point 301 as a starting point. The coordinate point 301 is a coordinate point obtained by mapping a delivery address included in a to-be-delivered order A. The geometrical pattern 302 corresponds to a delivery area identifier B. A total number of intersections of the half line 303 and sides of the geometrical pattern 302 being an odd number 3 may characterize that the coordinate point 301 is within the geometrical pattern 302, such that the electronic device may use the delivery area identifier B as a delivery area identifier corresponding to the to-be-delivered order A.

In some alternative implementations of the present embodiment, the delivery area identifier set may have a corresponding data structure, and the data structure may include leaf nodes and non-leaf nodes, where a leaf node is a node including no subnode, and each of the non-leaf nodes may include at least two subnodes. Each leaf node and each non-leaf node included in the data structure may correspond to different rectangular frames respectively, and may store position information of the corresponding rectangular frames. A rectangular frame corresponding to each of the above leaf nodes may be a minimal bounding rectangle of the geometrical pattern corresponding to the delivery area identifier in the delivery area identifier set. For each non-leaf node of the above non-leaf nodes, a rectangular frame corresponding to each subnode included in the non-leaf node may be contained within a rectangular frame corresponding to the non-leaf node. Here, position information of a rectangular frame, for example, may include coordinates of an upper left vertex and a lower right vertex and/or coordinates of an upper right vertex and a lower left vertex of the rectangular frame.

It should be noted that the data structure, for example, may be a directed graph, a tree structure, a R-tree spatial index structure, or the like. R-tree uses the idea of space division. The R-tree uses a method known as MBR (minimal bounding rectangle), and frames a space from the leaf node with a rectangle. The higher is the node, the larger is the framed space, thus dividing the space.

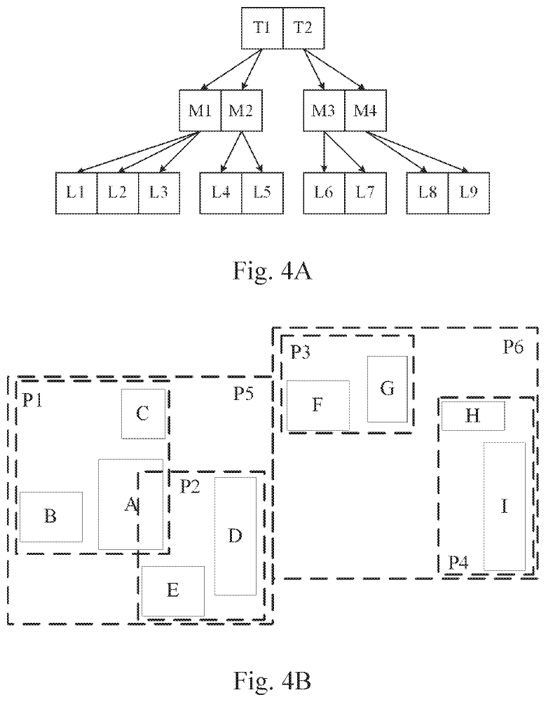

As shown in FIG. 4a, FIG. 4a shows a schematic diagram of a data structure. In FIG. 4a, the data structure includes leaf nodes L1, L2, L3, L4, L5, L6, L7, L8, and L9, and non-leaf nodes M1, M2, M3, M4, T1, and T2. The non-leaf nodes M1 and M2 are subnodes of the non-leaf node T1. The non-leaf nodes M3 and M4 are subnodes of the non-leaf node T2. The leaf nodes L1, L2, and L3 are subnodes of the non-leaf node M1. The leaf nodes L4 and L5 are subnodes of the non-leaf node M2. The leaf nodes L6 and L7 are subnodes of the non-leaf node M3. The leaf nodes L8 and L9 are subnodes of the non-leaf node M4.

As shown in FIG. 4b, FIG. 4b shows a schematic diagram of rectangular frames corresponding to a leaf node and a non-leaf node included in the data structure shown in FIG. 4a respectively. In FIG. 4b, rectangular frames A, B, and C are rectangular frames sequentially corresponding to the leaf nodes L1, L2, and L3, a rectangular frame P1 is a rectangular frame corresponding to the non-leaf node M1, and the rectangular frames A, B, and C are contained within the rectangular frame P1. Rectangular frames D and E are rectangular frames sequentially corresponding to the leaf node L4 and L5, a rectangular frame P2 is a rectangular frame corresponding to the non-leaf node M2, and the rectangular frames D and E are contained within the rectangular frame P2. A rectangular frame P5 is a rectangular frame corresponding to the non-leaf node T1, and the rectangular frames P1 and P2 are contained within the rectangular frame P5. In addition, rectangular frames F and G are rectangular frames sequentially corresponding to the leaf nodes L6 and L7, a rectangular frame P3 is a rectangular frame corresponding to the non-leaf node M3, and the rectangular frames F and G are contained within the rectangular frame P3. Rectangular frames H and I are rectangular frames sequentially corresponding to the leaf node L8 and L9, a rectangular frame P4 is a rectangular frame corresponding to the non-leaf node M4, and the rectangular frames H and I are contained within the rectangular frame P4. A rectangular frame P6 is a rectangular frame corresponding to the non-leaf node T2, and the rectangular frames P3 and P4 are contained within the rectangular frame P6.

In some alternative implementations of the present embodiment, for each to-be-delivered order in the to-be-delivered order set, after the electronic device maps the delivery address included in the to-be-delivered order to a coordinate point, the electronic device may further determine the delivery area identifier corresponding to the to-be-delivered order through executing the following steps: determining a target leaf node in the data structure based on the coordinate point obtained by the mapping and the position information of the rectangular frames respectively corresponding to the non-leaf nodes and the leaf nodes included in the data structure, where a rectangular frame corresponding to the target leaf node may be a rectangular frame of the coordinate point obtained by the mapping; and drawing a half line along a horizontal direction on a two-dimensional plane with the coordinate point obtained by the mapping as a starting point, determining a total number of intersections of the drawn half line and sides of the geometrical pattern within the rectangular frame corresponding to the target leaf node, and using, in response to the determined total number being an odd number, a delivery area identifier corresponding to the geometrical pattern within the rectangular frame corresponding to the target leaf node as the delivery area identifier corresponding to the to-be-delivered order. Thus, when the delivery area identifier set includes a large number of delivery area identifiers, the electronic device may determine a corresponding delivery area identifier for each to-be-delivered order in a short time by executing the steps.

Taking the data structures shown in FIGS. 4a and 4b respectively and the rectangular frames respectively corresponding to the leaf nodes and the non-leaf nodes included in the data structures as an example, assuming that the position information of a rectangular frame stored in the leaf nodes and the non-leaf nodes of the data structures is coordinates of the upper left vertex and the lower right vertex of the rectangular frame; a coordinate point mapped from a delivery address of a to-be-delivered order Q is J. First, the electronic device may determine a rectangular frame of the coordinate point J in the rectangular frames P5 and P6 corresponding to the non-leaf nodes T1 and T2 respectively. Then, in response to the electronic device determining that the coordinate point J is within the rectangular frame P5, the electronic device may determine the rectangular frame of the coordinate point J within the rectangular frames P1 and P2 corresponding to subnodes M1 and M2 of the non-leaf node T1 respectively. Then, in response to the electronic device determining that the coordinate point J is within the rectangular frame P1, the electronic device may determine the rectangular frame of the coordinate point J in the rectangular frames A, B, and C corresponding to subnodes L1, L2, and L3 of the non-leaf node M1 respectively. Finally, in response to the electronic device determining that the coordinate point J is within the rectangular frame A, the electronic device may determine the leaf node L1 as the target leaf node.

Here, taking the rectangular frame P5 as an example, and assuming that the position information of the rectangular frame P5 includes coordinates (x1, y1) of an upper right vertex and coordinates (x2, y2) of a lower left vertex of the rectangular frame P5, coordinates of the coordinate point J are (x, y). If x2<x<x1 and y1<y<y2, then the electronic device may determine that the coordinate point J is within the rectangular frame P5.

Step 203: dividing to-be-delivered orders corresponding to a given delivery area identifier in the to-be-delivered order set into a given to-be-delivered order group.

In the present embodiment, after the electronic device determines a delivery area identifier corresponding to each to-be-delivered order in the to-be-delivered order set, the electronic device may divide the to-be-delivered orders corresponding to the given delivery area identifier in the to-be-delivered order set into the given to-be-delivered order group, thereby obtaining at least one to-be-delivered order group.

Step 204: setting a group identifier for each divided to-be-delivered order group, and generating a corresponding relationship between the group identifier and a delivery area identifier corresponding to the divided to-be-delivered order group.

In the present embodiment, after the electronic device divides to-be-delivered order groups on the to-be-delivered order set, the electronic device may set the group identifier for each divided to-be-delivered order group, and generate the corresponding relationship between the group identifier and the delivery area identifier corresponding to the divided to-be-delivered order group. As an example, the electronic device may record the corresponding relationship between the group identifier and the delivery area identifier in the form of a key value pair, for example, forming a key value pair with the group identifier as a key, and the delivery area identifier as a value.

Here, the electronic device may connect remotely with a preset server for generating a group identifier. The electronic device may send the delivery area identifier corresponding to the to-be-delivered order group to the server for generating a group identifier, such that the server for generating a group identifier returns a group identifier. The electronic device may set the group identifier as the group identifier of the to-be-delivered order group.

In some alternative implementations of the present embodiment, each delivery area identifier in the delivery area identifier set may have a corresponding delivery mode identifier. The delivery mode identifier, e.g., may be a delivery mode identifier for indicating self-delivery or a delivery mode identifier for indicating delivery by third party logistics. The delivery mode identifier for indicating self-delivery or the delivery mode identifier for indicating delivery by the third party logistics may correspond to different group identifier generating approaches respectively. For each divided to-be-delivered order group, the electronic device may generate a group identifier based on a group identifier generating approach corresponding to a delivery mode identifier associated with the divided to-be-delivered order group, and set the generated group identifier as the group identifier of the divided to-be-delivered order group.

A generating approach corresponding to the delivery mode identifier indicating self-delivery, e.g., may include: a first character of the group identifier being a first preset character, a current timestamp following the first character, and a preset digit number (e.g., 5) of running numbers following the current timestamp. A generating approach corresponding to the delivery mode identifier for indicating delivery by third party logistics, e.g., may include: the first character of the group identifier being a second preset character, a current timestamp following the first character, and a preset digit number of running numbers following the current timestamp. The first preset character and the second preset character may be different from each other. The first preset character and the second preset character, e.g., may be a letter or a digit. It should be noted that the first preset character, the second preset character, and the preset digit number may be adjusted based on actual requirements. The present embodiment does not pose any limitation on contents in this aspect.

In some alternative implementations of the present embodiment, each to-be-delivered order in the to-be-delivered order set may further include an order identifier. For each divided to-be-delivered order group, the electronic device may further generate a corresponding relationship between the group identifier of the divided to-be-delivered order group and an order identifier of a to-be-delivered order included in the divided to-be-delivered order group. As an example, the electronic device may record the corresponding relationship between the group identifier and the order identifier of the to-be-delivered order included in the divided to-be-delivered order group in the form of a key value pair. For example, a key value pair is formed with the group identifier as a key, and with an order identifier list consisting of an order identifier of each to-be-delivered order included in the divided to-be-delivered order group as a value.

In some alternative implementations of the present embodiment, in response to the electronic device receiving prompt information including an order identifier of an abnormal order, the electronic device may determine a target to-be-delivered order group of the abnormal order from the divided to-be-delivered order groups, remove the abnormal order from the target to-be-delivered order group, and withdraw a corresponding relationship between the order identifier of the abnormal order and a group identifier of the target to-be-delivered order group. The abnormal order may be an undeliverable order in a divided to-be-delivered order group, e.g., an order for which a user pays and then applies for refund, or an order without corresponding inventory.

As an example, assuming that the group identifier of the target to-be-delivered order group and the order identifier of the to-be-delivered order included in the target to-be-delivered order group are stored in the form of a value key value pair, the electronic device may remove the order identifier of the abnormal order from the value of the key value pair.

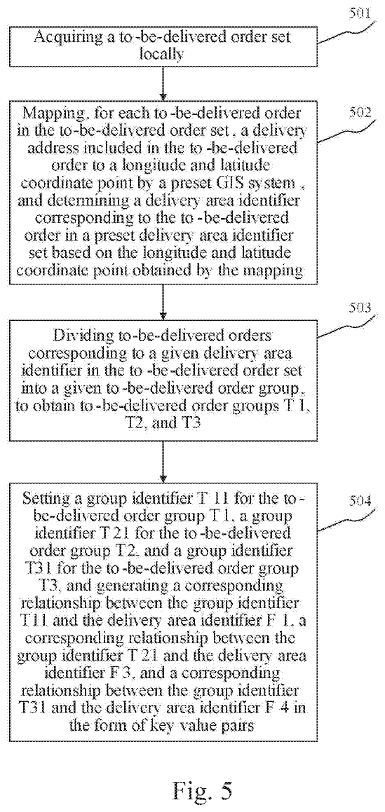

Further referring to FIG. 5, FIG. 5 is a schematic diagram of an application scenario of the method for processing information according to the present embodiment. In the application scenario of FIG. 5, a to-be-delivered order set is pre-stored in an information processing terminal locally. A to-be-delivered order includes a delivery address. As indicated by a reference numeral 501, the information processing terminal may acquire the to-be-delivered order set locally. Then, as indicated by a reference numeral 502, for each to-be-delivered order in the to-be-delivered order set, the information processing terminal may map a delivery address included in the to-be-delivered order to a longitude and latitude coordinate point by a preset GIS system, and determine a delivery area identifier corresponding to the to-be-delivered order in a preset delivery area identifier set based on the longitude and latitude coordinate point obtained by the mapping, where the delivery area identifier set includes delivery area identifiers F1, F2, F3, F4, and F5. Then, as indicated by a reference numeral 503, the information processing terminal may divide to-be-delivered orders corresponding to a given delivery area identifier in the to-be-delivered order set into a given to-be-delivered order group, to obtain to-be-delivered order groups T1, T2, and T3, where the to-be-delivered order group T1 corresponds to the delivery area identifier F1, the to-be-delivered order group T2 corresponds to the delivery area identifier F3, and the to-be-delivered order group T3 corresponds to the delivery area identifier F4. Finally, as indicated by a reference numeral 504, the information processing terminal may set a group identifier T11 for the to-be-delivered order group T1, a group identifier T21 for the to-be-delivered order group T2, and a group identifier T31 for the to-be-delivered order group T3, and generate a corresponding relationship between the group identifier T11 and the delivery area identifier F1, a corresponding relationship between the group identifier T21 and the delivery area identifier F3, and a corresponding relationship between the group identifier T31 and the delivery area identifier F4 in the form of key value pairs.

The method provided by the above embodiments of the present disclosure effectively uses the determined delivery area identifier corresponding to the to-be-delivered order, and achieves highly targeted information generation.

Further, the corresponding relationship between the generated group identifier and the delivery area identifier is applied to the delivery taking process of the deliveryman, such that the deliveryman can quickly acquire a to-be-delivered order group indicated by the group identifier, and further know about the delivery area of the delivery address of the to-be-delivered order, thereby shortening the delivery time of the deliveryman to improve the delivery efficiency of the deliveryman.

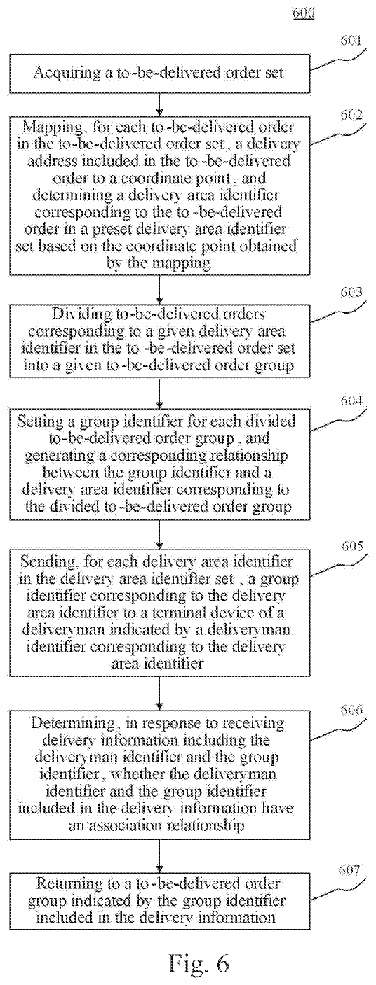

Further referring to FIG. 6, a process 600 of the method for processing information of another embodiment is shown. The process 600 of the method for processing information includes the following steps.

Step 601: acquiring a to-be-delivered order set.

Step 602: mapping, for each to-be-delivered order in the to-be-delivered order set, a delivery address included in the to-be-delivered order to a coordinate point, and determining a delivery area identifier corresponding to the to-be-delivered order in a preset delivery area identifier set based on the coordinate point obtained by the mapping.

Step 603: dividing to-be-delivered orders corresponding to a given delivery area identifier in the to-be-delivered order set into a given to-be-delivered order group.

Step 604: setting a group identifier for each divided to-be-delivered order group, and generating a corresponding relationship between the group identifier and a delivery area identifier corresponding to the to-be-delivered order group.

In the present embodiment, each delivery area identifier in the delivery area identifier set may have a corresponding deliveryman identifier. Here, the specific processing of step 601, step 602, step 603, and step 604 and the technical effects thereof may refer to the related description of step 201, step 202, step 203, and step 204 in the corresponding embodiment of FIG. 2, respectively. The description will not be repeated here.

Step 605: sending, for each delivery area identifier in the delivery area identifier set, a group identifier corresponding to the delivery area identifier to a terminal device of a deliveryman indicated by a deliveryman identifier corresponding to the delivery area identifier.

In the present embodiment, after executing step 604, for each delivery area identifier in the delivery area identifier set, the electronic device may send the group identifier corresponding to the delivery area identifier to the terminal device of the deliveryman indicated by the deliveryman identifier corresponding to the delivery area identifier by wired connection or wireless connection.

Step 606: determining, in response to receiving delivery information including the deliveryman identifier and the group identifier, whether the deliveryman identifier and the group identifier included in the delivery information have an association relationship.

In the present embodiment, the electronic device may further receive the delivery information including the deliveryman identifier and the group identifier sent by the deliveryman via the terminal device. If the electronic device receives the delivery information, the electronic device may determine whether the deliveryman identifier and the group identifier included in the delivery information have the association relationship. As an example, the electronic device may first determine a target delivery area identifier corresponding to the deliveryman identifier in the delivery area identifier set, then determine the group identifier corresponding to the target delivery area identifier in the generated corresponding relationship between the group identifier and the delivery area identifier of the to-be-delivered order group, and finally compare the group identifier corresponding to the target delivery area identifier with the group identifier included in the delivery information. If the group identifier corresponding to the target delivery area identifier is identical to the group identifier included in the delivery information, then the electronic device may determine that the deliveryman identifier and the group identifier included in the delivery information have the association relationship.

In some alternative implementations of the present embodiment, the group identifier of the to-be-delivered order group may be used for generating a barcode. A barcode generator application may be pre-installed on the electronic device. The electronic device may generate a barcode including the group identifier using the application. The above delivery information, e.g., may be sent by the deliveryman through scanning the barcode generated based on the group identifier using the terminal device.

Step 607: returning to a to-be-delivered order group indicated by the group identifier included in the delivery information.

In the present embodiment, in response to the electronic device determining that the deliveryman identifier and the group identifier included in the delivery information have the association relationship, the electronic device may return to the to-be-delivered order group indicated by the group identifier included in the delivery information.

As can be seen from FIG. 6, compared with the corresponding embodiment of FIG. 2, the process 600 of the method for processing information in the present embodiment highlights the steps of sending a group identifier and the receiving delivery information. The deliveryman identifier is pre-binded to the delivery area identifier, to prevent the deliveryman from selecting to-be-delivered orders (for example, some deliverymen will select the to-be-delivered orders based on the volume of goods and the distance of delivery areas). The group identifier is sent to the terminal device of the corresponding deliveryman, such that the deliveryman clearly knows about which to-be-delivered order groups are to be delivered by himself. After receiving the delivery information, whether the deliveryman identifier and the group identifier included in the delivery information have the association relationship is determined, to avoid returning to an incorrect to-be-delivered order group. When determining the deliveryman identifier and the group identifier included in the delivery information having the association relationship, the to-be-delivered order group indicated by the group identifier is returned to, such that the deliveryman can acquire each to-be-delivered order to be delivered by himself in a relatively short time. Since the delivery time is shortened, the delivery efficiency of the deliveryman will be further improved.

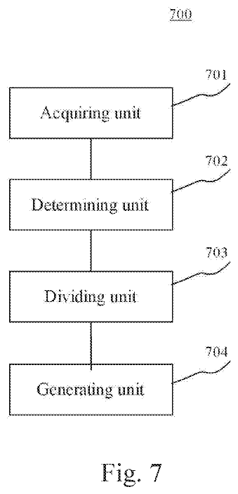

Further referring to FIG. 7, as an implementation of the method shown in the above figures, an embodiment of the present disclosure provides an apparatus for processing information. The embodiment of the apparatus corresponds to the embodiment of the method shown in FIG. 2. The apparatus may be specifically applied to various electronic devices.

As shown in FIG. 7, the apparatus 700 for processing information of the present embodiment includes: an acquiring unit 701, a determining unit 702, a dividing unit 703, and a generating unit 704. The acquiring unit 701 is configured to acquire a to-be-delivered order set, a to-be-delivered order including a delivery address; the determining unit 702 is configured to map, for each to-be-delivered order in the to-be-delivered order set, a delivery address included in the to-be-delivered order to a coordinate point, and determine a delivery area identifier corresponding to the to-be-delivered order in a preset delivery area identifier set based on the coordinate point obtained by the mapping; the dividing unit 703 is configured to divide to-be-delivered orders corresponding to a given delivery area identifier in the to-be-delivered order set into a given to-be-delivered order group; and the generating unit 704 is configured to set a group identifier for each divided to-be-delivered order group, and generate a corresponding relationship between the group identifier and a delivery area identifier corresponding to the to-be-delivered order group.

The specific processing of the acquiring unit 701, the determining unit 702, the dividing unit 703, and the generating unit 704 of the apparatus 700 for processing information and the technical effects thereof in the present embodiment may refer to the related description of step 201, step 202, step 203, and step 204 in the corresponding embodiment of FIG. 2, respectively. The description will not be repeated here.

In some alternative implementations of the present embodiment, each delivery area identifier in the delivery area identifier set may have a corresponding coordinate point sequence, each coordinate point in the coordinate point sequence may be a point on a boundary of a delivery area indicated by the delivery area identifier, the delivery area identifier may further have a corresponding geometrical pattern, and the geometrical pattern may be an enclosed pattern formed by connecting adjacent coordinate points in the coordinate point sequence.

In some alternative implementations of the present embodiment, the determining unit 702 may include: a first determining subunit (not shown in the figure) configured to draw a half line along a horizontal direction on a two-dimensional plane with the coordinate point obtained by the mapping as a starting point, determine, for each delivery area identifier in the delivery area identifier set, a total number of intersections of sides of the geometrical pattern corresponding to the delivery area identifier and the half line, and use, in response to the total number being an odd number, the delivery area identifier as the delivery area identifier corresponding to the to-be-delivered order.

In some alternative implementations of the present embodiment, the delivery area identifier set may have a corresponding data structure, the data structure may include leaf nodes and non-leaf nodes, where a leaf node may be a node including no subnode, and each of the non-leaf nodes may include at least two subnodes; each leaf node and each non-leaf node included in the data structure may correspond to different rectangular frames respectively, and store position information of corresponding rectangular frames; a rectangular frame corresponding to each leaf node may be a minimal bounding rectangle of the geometrical pattern corresponding to the delivery area identifier in the delivery area identifier set; and for each non-leaf node of the non-leaf nodes, a rectangular frame corresponding to each subnode included in the non-leaf node may be contained within a rectangular frame corresponding to the non-leaf node.

In some alternative implementations of the present embodiment, the determining unit 702 may further include: a second determining subunit (not shown in the figure) configured to determine a target leaf node in the data structure based on the coordinate point obtained by the mapping and the position information of the rectangular frames respectively corresponding to the non-leaf nodes and the leaf nodes included in the data structure, where a rectangular frame corresponding to the target leaf node is a rectangular frame of the coordinate point obtained by the mapping; and a third determining subunit (not shown in the figure) configured to draw a half line along a horizontal direction on a two-dimensional plane with the coordinate point obtained by the mapping as a starting point, determine a total number of intersections of the drawn half line and sides of a geometrical pattern within the rectangular frame corresponding to the target leaf node, and use, in response to the determined total number being an odd number, a delivery area identifier corresponding to the geometrical pattern within the rectangular frame corresponding to the target leaf node as the delivery area identifier corresponding to the to-be-delivered order.

In some alternative implementations of the present embodiment, the to-be-delivered orders in the to-be-delivered order set may be derived from an order set, each order in the order set may include identifier information, the to-be-delivered order set may be generated through the following steps: determining, for each order in the order set, whether a preset identifier in a preset identifier set exists in the identifier information included in the order, and classifying, in response to no preset identifier in the preset identifier set exists in the identifier information included in the order, the order into the to-be-delivered order set.

In some alternative implementations of the present embodiment, each delivery area identifier in the delivery area identifier set may have a corresponding delivery mode identifier, the delivery mode identifier may be a delivery mode identifier for indicating self-delivery or a delivery mode identifier for indicating delivery by third party logistics, and the delivery mode identifier for indicating self-delivery and the delivery mode identifier for indicating delivery by the third party logistics may correspond to different group identifier generating approaches respectively.

In some alternative implementations of the present embodiment, the generating unit 704 may include: a setting subunit (not shown in the figure) configured to generate, for each divided to-be-delivered order group, a group identifier based on a group identifier generating approach corresponding to a delivery mode identifier associated with the divided to-be-delivered order group, and set the generated group identifier as the group identifier of the divided to-be-delivered order group.

In some alternative implementations of the present embodiment, each to-be-delivered order in the to-be-delivered order set may further include an order identifier; and the apparatus 700 may further include: a first generating unit (not shown in the figure) configured to generate, for each divided to-be-delivered order group, a corresponding relationship between the group identifier of the divided to-be-delivered order group and an order identifier of a to-be-delivered order included in the to-be-delivered order group.

In some alternative implementations of the present embodiment, the apparatus 700 may further include: a removing unit (not shown in the figure) configured to determine, in response to receiving prompt information including an order identifier of an abnormal order, a target to-be-delivered order group of the abnormal order from the divided to-be-delivered order groups, remove the abnormal order from the target to-be-delivered order group, and withdraw a corresponding relationship between the order identifier of the abnormal order and a group identifier of the target to-be-delivered order group, where the abnormal order may be an undeliverable order in a divided to-be-delivered order group.

In some alternative implementations of the present embodiment, each delivery area identifier in the delivery area identifier set may have a corresponding deliveryman identifier; and the apparatus 700 may further include: a first sending unit (not shown in the figure) configured to send, for each delivery area identifier in the delivery area identifier set, a group identifier corresponding to the delivery area identifier to a terminal device of a deliveryman indicated by the deliveryman identifier corresponding to the delivery area identifier.

In some alternative implementations of the present embodiment, the apparatus 700 may further include: a second sending unit (not shown in the figure) configured to determine, in response to receiving delivery information including the deliveryman identifier and the group identifier, whether the deliveryman identifier and the group identifier included in the delivery information have an association relationship, and return to, in response to the deliveryman identifier and the group identifier included in the delivery information having the association relationship, a to-be-delivered order group indicated by the group identifier included in the delivery information.

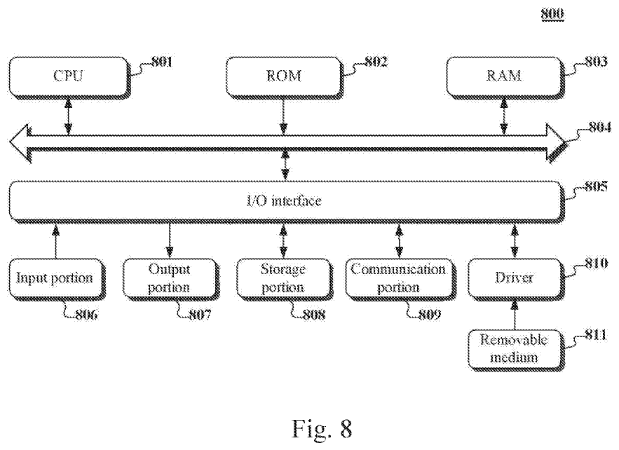

With further reference to FIG. 8, a schematic structural diagram of a computer system 600 adapted to implement the electronic device of embodiments of the present disclosure is shown. The electronic device shown in FIG. 8 is merely an example, and should not impose any limitation on the function and scope of use of the embodiments of the present disclosure.

As shown in FIG. 8, the computer system 800 includes a central processing unit (CPU) 801, which may execute various appropriate actions and processes in accordance with a program stored in a read-only memory (ROM) 802 or a program loaded into a random access memory (RAM) 803 from a storage portion 808. The RAM 803 also stores various programs and data required by operations of the system 800. The CPU 801, the ROM 802 and the RAM 803 are connected to each other through a bus 604. An input/output (I/O) interface 805 is also connected to the bus 804.

The following components are connected to the I/O interface 805: an input portion 806 including a keyboard, a mouse, etc.; an output portion 807 including such as a cathode ray tube (CRT), a liquid crystal display device (LCD), a speaker, etc.; a storage portion 808 including a hard disk and the like; and a communication portion 809 including a network interface card, such as a LAN card and a modem. The communication portion 809 performs communication processes via a network, such as the Internet. A driver 810 is also connected to the I/O interface 805 as required. A removable medium 811, such as a magnetic disk, an optical disk, a magneto-optical disk, and a semiconductor memory, may be installed on the driver 810, to facilitate the retrieval of a computer program from the removable medium 811, and the installation thereof on the storage portion 808 as needed.

In particular, according to the embodiments of the present disclosure, the process described above with reference to the flow chart may be implemented in a computer software program. For example, an embodiment of the present disclosure includes a computer program product, which includes a computer program that is tangibly embedded in a computer-readable medium. The computer program includes program codes for performing the method as illustrated in the flow chart. In such an embodiment, the computer program may be downloaded and installed from a network via the communication portion 609, and/or may be installed from the removable medium 811. The computer program, when executed by the central processing unit (CPU) 801, implements the above-mentioned functionalities as defined by the method of the present disclosure. It should be noted that the computer readable medium in the present disclosure may be computer readable signal medium or computer readable storage medium or any combination of the above two.

It should be noted that, the computer readable storage medium in an embodiment of the present disclosure may include, but not limited to: electric, magnetic, optical, electromagnetic, infrared, or semiconductor systems, apparatus, elements, or a combination of any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fiber, a portable compact disk read only memory (CD-ROM), an optical memory, a magnet memory or any suitable combination of the above. In the present disclosure, the computer readable storage medium may be any physical medium containing or storing programs which may be used by a command execution system, apparatus or element or incorporated thereto. In the present disclosure, the computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion including one or more executable instructions for implementing specified logic functions. It should also be noted that, in some alternative implementations, the functions denoted by the blocks may occur in a sequence different from the sequences shown in the accompanying drawings. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system performing specified functions or operations, or by a combination of a dedicated hardware and computer instructions.

The units involved in some embodiments of the present disclosure may be implemented by software or hardware. The described units may also be provided in a processor, for example, described as: a processor including an acquiring unit, a determining unit, a dividing unit, and a generating unit. The names of the units do not constitute a limitation to such units themselves in some cases. For example, the acquiring unit may be further described as “a unit configured to acquire a to-be-delivered order set.”

In another aspect, an embodiment of the present disclosure further provides a computer readable medium. The computer readable medium may be included in the electronic device described in the above embodiments, or a stand-alone computer readable medium without being assembled into the electronic device. The computer readable medium stores one or more programs. The one or more programs, when executed by the electronic device, cause the electronic device to: acquire a to-be-delivered order set, a to-be-delivered order including a delivery address; map, for each to-be-delivered order in the to-be-delivered order set, a delivery address included in the to-be-delivered order to a coordinate point, and determine a delivery area identifier corresponding to the to-be-delivered order in a preset delivery area identifier set based on the coordinate point obtained by the mapping; divide to-be-delivered orders corresponding to a given delivery area identifier in the to-be-delivered order set into a given to-be-delivered order group; and set a group identifier for each divided to-be-delivered order group, and generate a corresponding relationship between the group identifier and a delivery area identifier corresponding to the divided to-be-delivered order group.

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the present disclosure. Technical schemes formed by the above-described features being interchanged with, but not limited to, technical features with similar functions disclosed in the present disclosure are examples.

1. A method for processing information, comprising:
acquiring a to-be-delivered order set, a to-be-delivered order comprising a delivery address;
mapping, for each to-be-delivered order in the to-be-delivered order set, a delivery address included in the to-be-delivered order to a coordinate point, and determining a delivery area identifier corresponding to the to-be-delivered order in a preset delivery area identifier set based on the coordinate point obtained by the mapping;
dividing to-be-delivered orders corresponding to a given delivery area identifier in the to-be-delivered order set into a given to-be-delivered order group; and
setting a group identifier for each divided to-be-delivered order group, and generating a corresponding relationship between the group identifier and a delivery area identifier corresponding to the to-be-delivered order group.

2. The method according to claim 1, wherein each delivery area identifier in the delivery area identifier set has a corresponding coordinate point sequence, each coordinate point in the coordinate point sequence is a point on a boundary of a delivery area indicated by the delivery area identifier, the delivery area identifier further has a corresponding geometrical pattern, and the geometrical pattern is an enclosed pattern formed by connecting adjacent coordinate points in the coordinate point sequence.

3. The method according to claim 2, wherein the determining a delivery area identifier corresponding to the to-be-delivered order in a preset delivery area identifier set based on the coordinate point obtained by the mapping comprises:
drawing a half line along a horizontal direction on a two-dimensional plane with the coordinate point obtained by the mapping as a starting point, determining, for each delivery area identifier in the delivery area identifier set, a total number of intersections of sides of the geometrical pattern corresponding to the delivery area identifier and the half line, and using, in response to the total number being an odd number, the delivery area identifier as the delivery area identifier corresponding to the to-be-delivered order.

4. The method according to claim 2, wherein the delivery area identifier set has a corresponding data structure, the data structure comprises leaf nodes and non-leaf nodes, wherein a leaf node is a node comprising no subnode, and each of the non-leaf nodes comprises at least two subnodes; each leaf node and each non-leaf node included in the data structure correspond to different rectangular frames respectively, and store position information of corresponding rectangular frames; a rectangular frame corresponding to the each leaf node is a minimal bounding rectangle of the geometrical pattern corresponding to the delivery area identifier in the delivery area identifier set; and for the each non-leaf node of the non-leaf nodes, a rectangular frame corresponding to each subnode included in the non-leaf node is contained within a rectangular frame corresponding to the non-leaf node.

5. The method according to claim 4, wherein the determining a delivery area identifier corresponding to the to-be-delivered order in a preset delivery area identifier set based on the coordinate point obtained by the mapping further comprises:
determining a target leaf node in the data structure based on the coordinate point obtained by the mapping and the position information of the rectangular frames respectively corresponding to the non-leaf node and the leaf node included in the data structure, wherein a rectangular frame corresponding to the target leaf node is a rectangular frame of the coordinate point obtained by the mapping; and
drawing a half line along a horizontal direction on a two-dimensional plane with the coordinate point obtained by the mapping as a starting point, determining a total number of intersections of the drawn half line and sides of a geometrical pattern within the rectangular frame corresponding to the target leaf node, and using, in response to the determined total number being an odd number, a delivery area identifier corresponding to the geometrical pattern within the rectangular frame corresponding to the target leaf node as the delivery area identifier corresponding to the to-be-delivered order.

6. The method according to claim 1, wherein to-be-delivered orders in the to-be-delivered order set are derived from an order set, each order in the order set comprises identifier information, and the to-be-delivered order set is generated by:
determining, for the each order in the order set, whether a preset identifier in a preset identifier set exists in the identifier information included in the order, and classifying, in response to no preset identifier in the preset identifier set exists in the identifier information included in the order, the order into the to-be-delivered order set.

7. The method according to claim 1, wherein each delivery area identifier in the delivery area identifier set has a corresponding delivery mode identifier, the delivery mode identifier being a delivery mode identifier for indicating self-delivery or a delivery mode identifier for indicating delivery by third party logistics, and the delivery mode identifier for indicating self-delivery and the delivery mode identifier for indicating delivery by the third party logistics correspond to different group identifier generating approaches respectively.

8. The method according to claim 7, wherein the setting a group identifier for each divided to-be-delivered order group comprises:
generating, for the each divided to-be-delivered order group, a group identifier based on a group identifier generating approach corresponding to a delivery mode identifier associated with the divided to-be-delivered order group, and setting the generated group identifier as the group identifier of the to-be-delivered order group.

9. The method according to claim 1, wherein the each to-be-delivered order in the to-be-delivered order set further comprises an order identifier; and
the method further comprises:
generating, for the each divided to-be-delivered order group, a corresponding relationship between the group identifier of the to-be-delivered order group and an order identifier of a to-be-delivered order included in the to-be-delivered order group.

10. The method according to claim 9, wherein the method further comprises:
determining, in response to receiving prompt information comprising an order identifier of an abnormal order, a target to-be-delivered order group of the abnormal order from the divided to-be-delivered order groups, removing the abnormal order from the target to-be-delivered order group, and withdrawing a corresponding relationship between the order identifier of the abnormal order and a group identifier of the target to-be-delivered order group, wherein the abnormal order is an undeliverable order in a divided to-be-delivered order group.

11. The method according to claim 1, wherein the each delivery area identifier in the delivery area identifier set has a corresponding deliveryman identifier; and
the method further comprises:
sending, for the each delivery area identifier in the delivery area identifier set, a group identifier corresponding to the delivery area identifier to a terminal device of a deliveryman indicated by the deliveryman identifier corresponding to the delivery area identifier.

12. The method according to claim 11, wherein the method further comprises:
determining, in response to receiving delivery information comprising the deliveryman identifier and the group identifier, whether the deliveryman identifier and the group identifier included in the delivery information have an association relationship, and returning to, in response to the deliveryman identifier and the group identifier included in the delivery information having the association relationship, a to-be-delivered order group indicated by the group identifier included in the delivery information.

13. An apparatus for processing information, comprising:
at least one processor; and
a memory storing instructions, wherein the instructions when executed by the at least one processor, cause the at least one processor to perform operations, the operations comprising:
acquiring a to-be-delivered order set, each to-be-delivered order in the to-be-delivered order set comprising a delivery address;
mapping, for each to-be-delivered order in the to-be-delivered order set, the delivery address included in the to-be-delivered order to a coordinate point, and determining a delivery area identifier corresponding to the to-be-delivered order in a preset delivery area identifier set based on the coordinate point obtained by the mapping;
dividing to-be-delivered orders corresponding to a given delivery area identifier in the to-be-delivered order set into a given to-be-delivered order group; and
setting a group identifier for each divided to-be-delivered order group, and generating a corresponding relationship between the group identifier and a delivery area identifier corresponding to the to-be-delivered order group.

14. (canceled)

15. A non-transitory computer readable storage medium, storing a computer program thereon, wherein the program, when executed by a processor, implements the method according to claim 1.
